(19) United States
(12) Patent Application Publication
(10) Pub. No.: US 2015/0117730 A1
(43) Pub. Date: Apr. 30, 2015

(54) IMAGE PROCESSING METHOD AND IMAGE PROCESSING SYSTEM

(71) Applicant: CANON KABUSHIKI KAISHA, Tokyo (JP)

(72) Inventor: Tomohiko Takayama, Tokyo (JP)

(21) Appl. No.: 14/510,278

(22) Filed: Oct. 9, 2014

(30) Foreign Application Priority Data
Oct. 29, 2013 (JP) 2013-224366

(51) Int. Cl. G06T 7/00; G06K 9/46

(52) U.S. Cl. CPC G06T 7/0022; G06T 7/0065; G06K 9/46; G06T 2207/10056; G06T 2207/30096; G06T 2207/20221
USPC 382/128

(57) ABSTRACT

An image processing method, includes: acquiring data on a plurality of sample images, acquired by imaging a plurality of samples collected from different positions of a gross organ that includes a lesion, by a computer; extracting information on the lesion from each of the plurality of sample images; and generating data on a pathological information image by combining information on the lesion extracted from each of the plurality of sample images, on an image expressing the gross organ, by the computer.

### BACKGROUND OF THE INVENTION

1. Field of the Invention

The present invention relates to an image processing method and an image processing system.

2. Description of the Related Art

A virtual slide system, which images a sample on a slide using a digital microscope, acquires a virtual slide image (hereafter called “slide image”), and displays this image on a monitor for observation is receiving attention (see Japanese Patent Application Laid-open No. 2011-118107).

A pathological image system technique, for managing and displaying a gross image (digital image of a lesion area) and a slide image (microscopic digital image) separately and linking these images, is also known (see Japanese Patent Application Laid-open No. 2000-276545).

### SUMMARY OF THE INVENTION

Based on the pathological image system technique disclosed in Japanese Patent Application Laid-open No. 2000-276545, the gross image and the slide image can be managed and displayed as linked with each other, but the area of the gross image that corresponds to the slide image, or the correspondence of the lesion in the gross image and in the slide image, cannot be recognized.

With the foregoing in view, it is an object of the present invention to provide a technique that allows visually and intuitively recognizing the correspondence of information acquired from a gross organ and information acquired from a plurality of samples collected from the gross organ.

The present invention in its first aspect provides an image processing method, comprising: acquiring data on a plurality of sample images, acquired by imaging a plurality of samples collected from different positions of a gross organ that includes a lesion, by a computer; extracting information on the lesion from each of the plurality of sample images; and generating data on a pathological information image by combining information on the lesion extracted from each of the plurality of sample images, on an image expressing the gross organ, by the computer.

The present invention in its second aspect provides an image processing system, comprising: an acquiring unit configured to acquire data on a plurality of sample images, acquired by imaging a plurality of samples collected from different positions of a gross organ that includes a lesion; an information extracting unit configured to extract information on a lesion from each of the plurality of sample images; and a data generating unit configured to generate data on a pathological information image by combining information on the lesion extracted from each of the plurality of sample images, on an image expressing the gross organ.

The present invention in its third aspect provides a non-transitory computer-readable storage medium that records a program for a computer to execute each step of the image processing method according to the present invention.

According to the present invention, it is possible to generate an image (a pathological information image) that allows visually and intuitively recognizing the correspondence of information acquired from a gross organ and information acquired from a plurality of samples collected from the gross organ.

Further features of the present invention will become apparent from the following description of exemplary embodiments with reference to the attached drawings.

### BRIEF DESCRIPTION OF THE DRAWINGS

FIG. 1A to FIG. 1E are schematic diagrams depicting pathological diagnostic processing steps;

FIG. 2 is a flow chart depicting the pathological diagnostic processing steps;

FIG. 3 are schematic diagrams depicting stomach extirpation patterns;

FIG. 4A and FIG. 4B are schematic diagrams depicting a gross organ;

FIG. 5A and FIG. 5B are schematic diagrams depicting a gross extirpation;

FIG. 6A and FIG. 6B are schematic diagrams depicting a slide;

FIG. 7A and FIG. 7B are schematic diagrams depicting the positional relationship of a gross organ and slides;

FIG. 8 is a flow chart depicting pathological information image data generation;

FIG. 9A to FIG. 9C are schematic diagrams depicting pathological information extraction from the gross image;

FIG. 10A to FIG. 10B are flow charts depicting pathological information extraction from a gross image;

FIG. 11A and FIG. 11B are a schematic diagram and a table depicting the pathological information extraction from a slide image;

FIG. 12A to FIG. 12D are schematic diagrams depicting the alignment of a plurality of slide images;

FIG. 13A and FIG. 13B are flow charts depicting pathological information extraction from a slide image;

FIG. 14A and FIG. 14B are schematic diagrams depicting macro-lesion areas and micro-lesion areas;

FIG. 15A to FIG. 15C are schematic diagrams depicting the alignment of a gross image and slide images;

FIG. 16 is a flow chart depicting the alignment of a gross image and slide images;

FIG. 17A to FIG. 17C are schematic diagrams depicting the generation and display of pathological information image data;

FIG. 18 is a flow chart depicting the generation and display of pathological information image data;

FIG. 19 is a general view of a device configuration of the image processing system; and

FIG. 20 is a functional block diagram of the image processor.

### DESCRIPTION OF THE EMBODIMENTS

The present invention relates to a technique to generate an image which is effective for pathological diagnosis from a plurality of sample images captured by a digital microscope or the like. In concrete terms, information on a lesion is extracted from a plurality of sample images collected from different positions of a gross organ (all or part of an internal organ), and data on the pathological information image is generated by combining the extracted information on an image expressing the gross organ. By displaying this pathological information image, the correspondence of information acquired from a plurality of samples collected from the gross organ and information acquired from the gross organ can be visually and intuitively recognized. When information on a lesion extracted from each sample image is combined at a corresponding position on the image expressing the gross organ at this time, so that the correspondence of the gross organ and the position from which each sample was collected can be recognized, then the position, range, progress or the like of the lesion in the gross organ can be accurately and intuitively recognized.

Now the preferred embodiments of the present invention will be described with reference to the drawings.

### Example 1

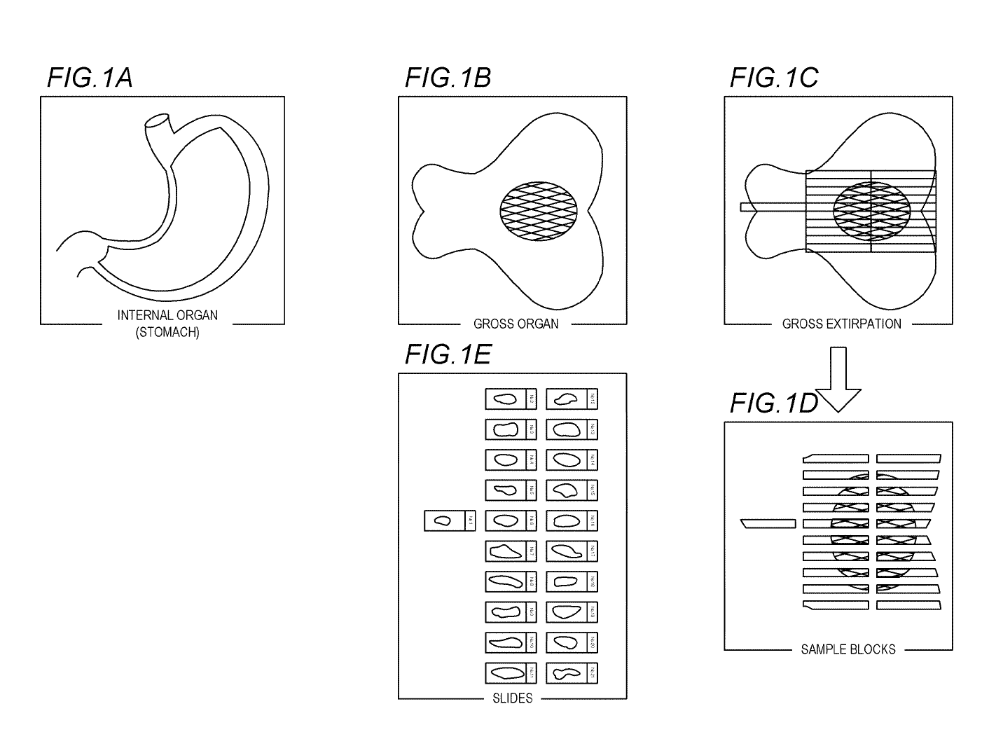

The image processing method of the present invention can be used in the pathological diagnostic processing steps. These pathological diagnostic processing steps will be described with reference to FIG. 1 to FIG. 7.

### Pathological Diagnostic Processing Steps

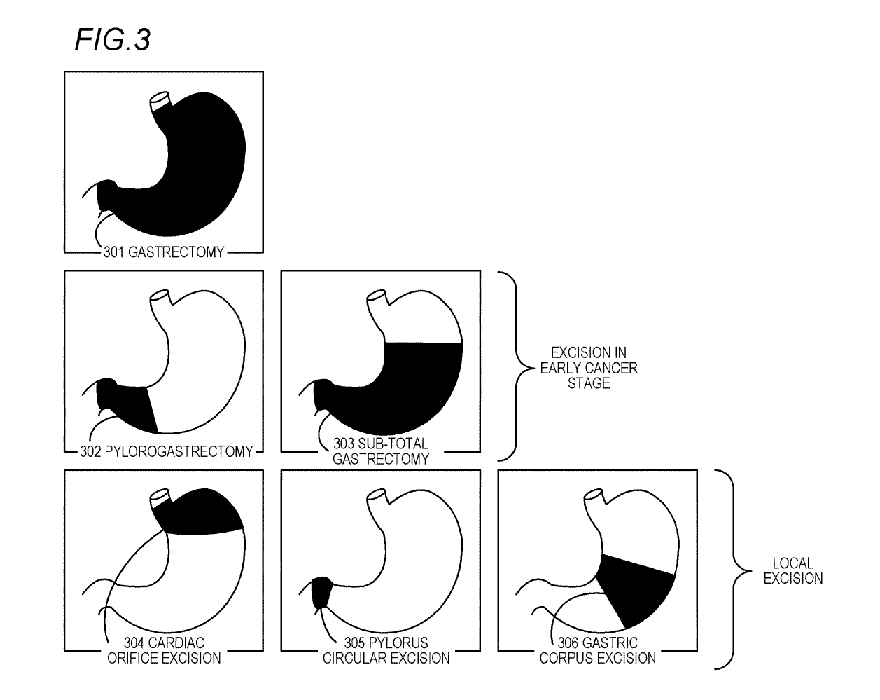

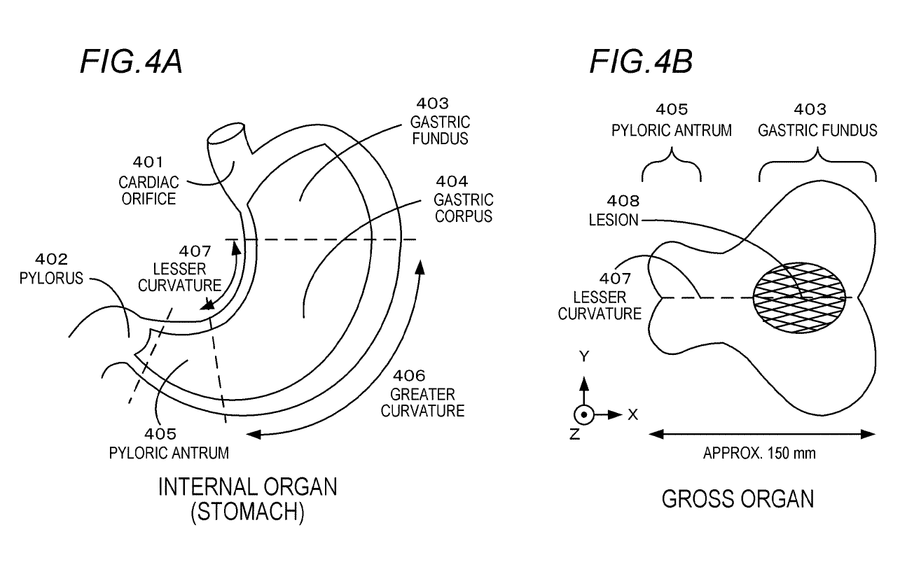

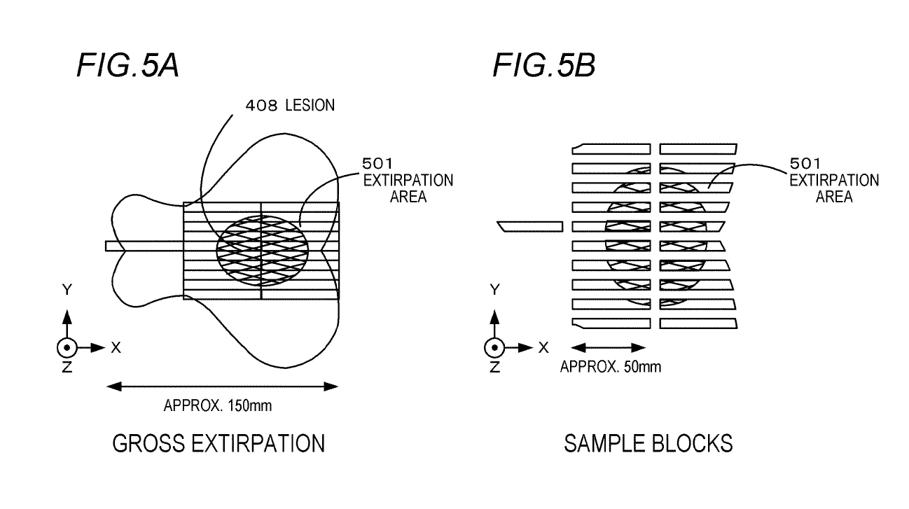

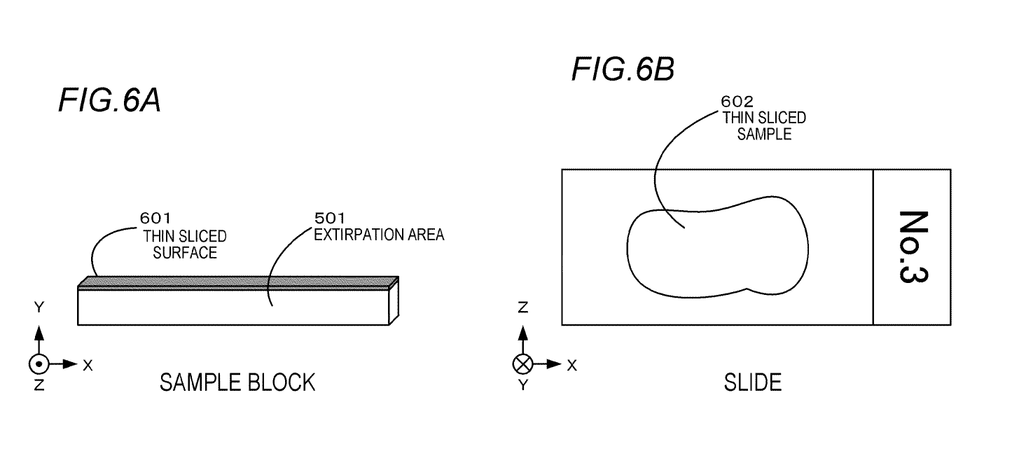

FIG. 1A to FIG. 1E are schematic diagrams depicting the pathological diagnostic processing steps. The typical state in steps, from total gastrectomy (total stomach extirpation) to pathological diagnostic slide creation, are shown in the drawings. FIG. 1A is a diagram depicting a general image of a stomach. In this example, total gastrectomy (total stomach extirpation) is described as an example. The typical excision range of a stomach will be described in FIG. 3. FIG. 1B is a diagram depicting a total extirpated stomach. In this example, the entire organ that is excised, then treated and fixed is referred to as a “gross organ”. Details will be described in FIG. 4A and FIG. 4B. FIG. 1C is a diagram depicting an extirpation area of the gross organ. FIG. 1D is a diagram depicting sample blocks after the gross organ is extirpated. In this example, an organ section after the extirpation is called a “sample block”. Details on the gross extirpation and the sample block will be described in FIG. 5A and FIG. 5B. FIG. 1E is a diagram depicting the slides created from each sample block. Details on a slide will be described in FIG. 6A and FIG. 6B.

Now, how the pathological diagnostic processing steps described in FIG. 1A to FIG. 1E correspond to processes in the flow from the examination to the treatment selection will be described in brief. If a stomach cancer is suspected from a stomach X-ray examination or endoscopic examination during a medical examination, a pathological examination is performed by endoscopic biopsy (lesion sampling). If a malignant tumor is suspected in the pathological examination, staging (progress state of the stomach cancer) is diagnosed by ultrasound examination, CT scan, irrigoscopy or the like. Then it is determined whether endoscopic treatment is necessary or whether gastrectomy is required. The pathological diagnostic processing steps shown in FIG. 1A to FIG. 1E are steps, taken when gastrectomy is chosen, from gastrectomy (total stomach extirpation) to pathological diagnosis. As a result of the pathological diagnosis, a treatment plan, such as follow up observation and chemotherapy, is determined.

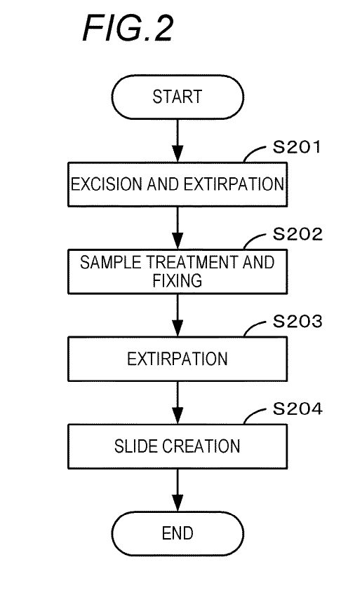

FIG. 2 is a flow chart depicting the pathological diagnostic processing steps.

In step S201, a stomach (internal organ) is excised and extirpated. The excised range is determined by comprehensively judging the location and stage of the lesion, the age and medical history of the patient or the like. The typical excision ranges of a stomach will be described in FIG. 3. This step S201 corresponds to FIG. 1A.

In step S202, the sample is treated and fixed. The stomach excised and extirpated in step S201 is saved in a diluted formalin solution to fix the organ. Fixing prevents tissue from being degenerated, stabilizes its shape and structure, strengthens its stainability and maintains its antigenicity. This step S202 corresponds to FIG. 1B.

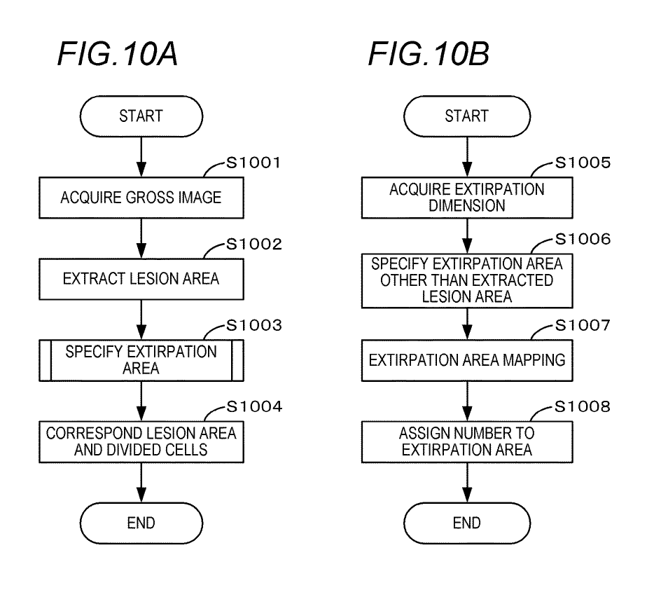

In step S203, extirpation is performed. The lesion area is extirpated based on the judgment of the pathologist. Not only a lesion area that can be visually recognized, but also an area where lesions tend to occur is extirpated. The gross organ and the sample blocks are imaged before and after extirpation, so as to confirm the correspondence of “the gross organ as macro-information” and “the slides as micro-information”. The gross image before extirpation corresponds to the image in FIG. 10, and the image of the sample blocks after extirpation corresponds to the image in FIG. 1D. This step S203 corresponds to FIG. 1C and FIG. 1D.

Slides are created in step S204. The slides are created from the sample blocks via such steps as drying, paraffin embedding, slicing, staining, sealing, labeling and segment checking. Hematoxylin-eosin (HE) stained slides are created for biopsy.

FIG. 3 is a schematic diagram depicting a stomach extirpation pattern. The excised range is determined by comprehensively judging the location and stage of the lesion, the age and medical history of the patient or the like. Gastrectomy (total stomach extirpation) 301 is performed for a progressive cancer around the gastric fundus and gastric corpus, or for an undifferentiated cancer that has spread throughout the stomach. In the early stage of a cancer, pylorogastrectomy 302 and sub-total gastrectomy 303 are performed, and if the spread of the lesion is local and there is no risk of metastasis, cardiac orifice excision 304, pylorus circular excision 305 and gastric corpus excision 306 are performed.

FIG. 4A and FIG. 4B are schematic diagrams depicting a gross organ. FIG. 4A is a general view of a stomach, where a name of each portion of the stomach is shown. FIG. 4B is a general view of a gross organ, where a name of each portion of the stomach is shown, as in FIG. 4A, so as to easily recognize the correspondence with the general view of the stomach. FIG. 4A and FIG. 4B correspond to the processing operations in steps S201 and S202 in FIG. 2.

FIG. 4A shows a cardiac orifice 401 which is linked to the gullet, a pylorus 402 which is linked to the duodenum, a gastric fundus 403 which is an upper portion of the stomach, a gastric corpus 404 which is a middle portion of the stomach, a pyloric antrum 405 which is a lower portion of the stomach, a greater curvature 406 which is an outer curvature of the stomach, and a lesser curvature 407 which is an inner curvature of the stomach.

The gross organ shown in FIG. 4B is an organ on which gastrectomy, incision of an extirpated stomach, and sample treatment and fixing were performed. The lesion of a stomach is often generated in the lesser curvature 407, therefore normally the greater curvature is incised, and this example is described according to this case. A visually recognized lesion 408 near the lesser curvature 407 of the gastric fundus 403 is indicated as a shaded ellipse. The XYZ positional coordinates are indicated to clarify the positional relationship of the gross organ (macro-information) and slides (micro-information). FIG. 4B is an XY cross-sectional view (top view) of the gross organ. For reference, the gross length (approx. 150 mm) is indicated so that the dimensions of the gross organ (micro-information) and the slides (micro-information) can be easily grasped.

FIG. 5A and FIG. 5B are schematic diagrams depicting a gross extirpation, which corresponds to the processing in step S203 in FIG. 2.

FIG. 5A shows a gross image in which extirpation areas are indicated. A plurality of extirpation areas are determined so as to contain an area that includes a lesion 408 that can be visually recognized, and a lesser curvature portion where a lesion is frequently generated. There are 21 extirpation areas in the case of FIG. 5A. Extirpation area 501 is one of a plurality of extirpation areas. The dimensions of extirpation areas are determined with consideration to a thin sliced sample that is later mounted on a slide. Here the sample mounting dimensions of the slide is 60 mm×26 mm, so the longitudinal length of the sample block is set to approx. 50 mm, which is ⅓ that of the approx. 150 mm gross length, so that the sample block can be included in the sample mounting dimensions of the slide. FIG. 5A is an XY cross-sectional view (top view) of the gross organ.

FIG. 5B shows sample blocks after extirpation. 21 sample blocks are created. FIG. 5B is an XY cross-sectional view (top view) of the sample blocks.

FIG. 6A and FIG. 6B are schematic diagrams depicting a slide, and correspond to the processing in step S204 in FIG. .

FIG. 6A shows a sample block after extirpation. Drying and paraffin embedding are performed for each sample block, and the sample block is then sliced thin.

The pathologist selects the thin sliced surface 601 when extirpation is performed. This thin sliced surface 601 is an XZ cross-section. This is because the invasion depth of the lesion in the thickness direction (Z direction) of stomach walls is determined in the pathological diagnosis. The cross-sections shown in FIG. 4B, FIG. 5A and FIG. 5B are XY cross-sections, while the thin sliced surface 601 is an XZ cross-section.

FIG. 6B shows a slide on which the thin sliced sample 602 is mounted. The slide is created from a thin sliced sample via staining, sealing, labeling and segment checking. In this example, one slide is created for each sample block. Note that the directions of the XYZ positional coordinates are the opposite in FIG. 6A and FIG. 6B.

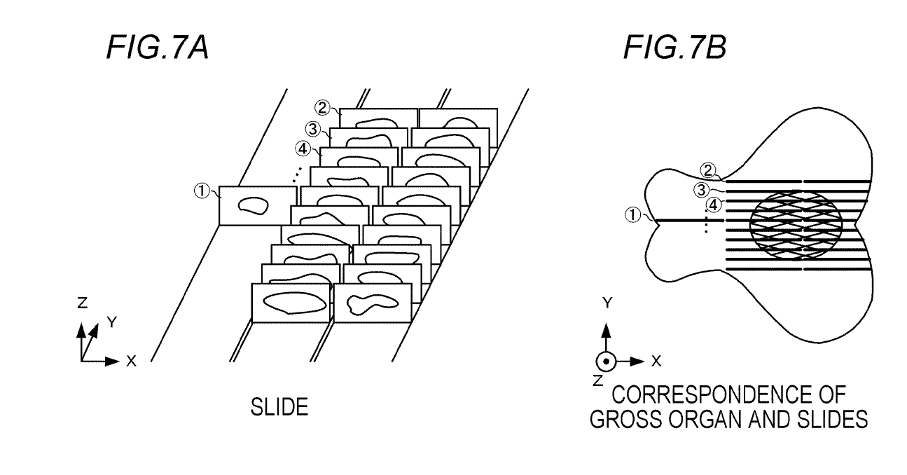

FIG. 7A and FIG. 7B are schematic diagrams depicting the positional relationship of the gross organ and slides.

FIG. 7A are slide arrangements in the XYZ positional coordinates. To determine the invasion depth of the lesion in the depth direction (Z direction) in the pathological diagnosis, the thin sliced sample mounted on each slide indicates an XY cross-section. In this example, 21 slides are created for one gross organ.

FIG. 7B shows the positional relationship of the gross organ and the slides in each XY cross-section. The slide contains an area that includes the lesion 408 which can be visually recognized, and the lesser curvature portion where a lesion is frequently generated. The lesion 408 is discretely sampled corresponding to the arrangement of the slides.

The “micro-pathological information extracted from the discretely sampled slides” and the “macro-pathological information extracted from the gross organ” shown in FIG. 7B are integrated in the pathological diagnosis, and the spread, stage of the lesion or the like are determined in the entire gross organ. The operation to link the micro-pathological information extracted from the slides (slide pathological information) and the macro-pathological information acquired from the gross organ (gross pathological information) is performed daily by a pathologist. However it is not easy to share such information with clinicians and patients accurately and quickly, since this operation and the information requires a high degree of expertise. An object of this example is to visually link the micro-pathological information extracted from the slides (slide pathological information) and the macro-pathological information acquired from the gross organ (gross pathological information), and to share this information accurately and quickly.

### Description on Image Processing Method

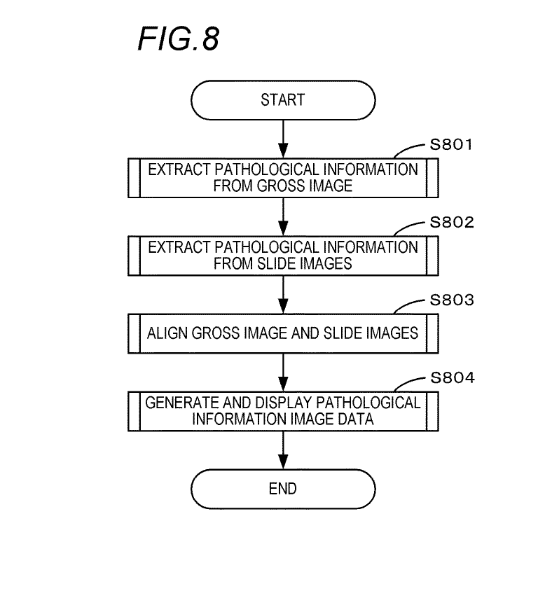

The image processing method of this example will be described with reference to FIG. 8 to FIG. 17C. The image processing method described hereinbelow is executed by, for example, a computer, in which an image processing program is installed (image processing system). In other words, the image processing system (computer or CPU) executes each step of the image processing method that is described hereinbelow. A configuration example of the image processing system will be described later.

(0) General Flow

FIG. 8 is a flow chart depicting pathological information image data generation according to the image processing method of this example.

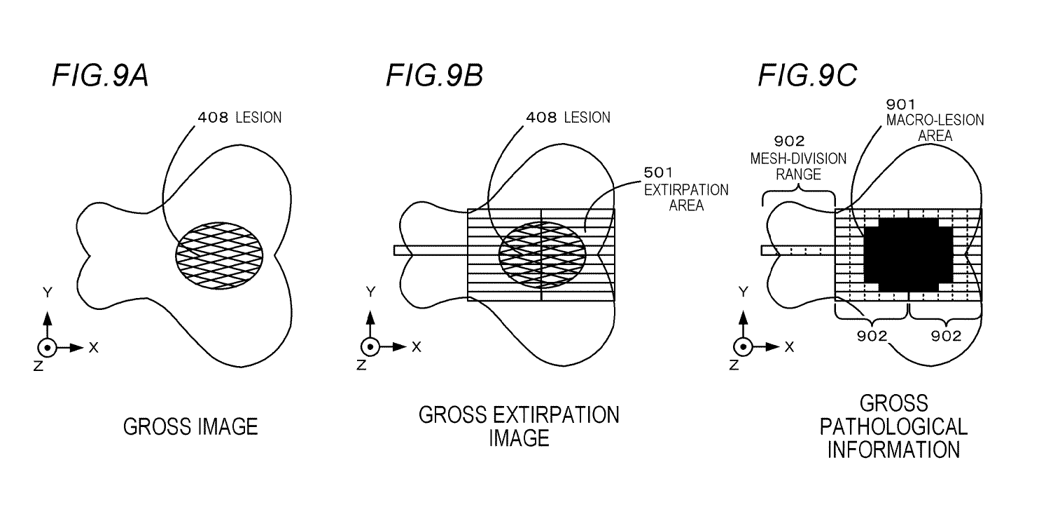

In step S801, the pathological information is extracted from the gross image. Details will be described in FIG. 9A to FIG. 10B.

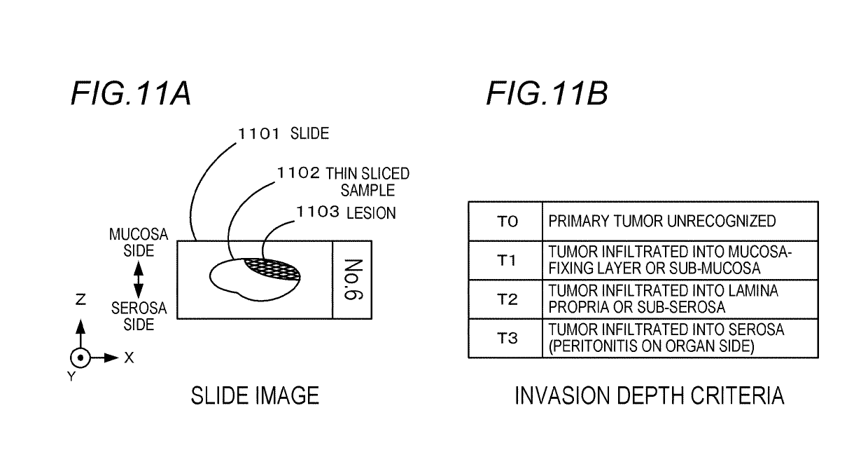

In step S802, the pathological information is extracted from the slide images. Details will be described in FIG. 11A to FIG. 13B.

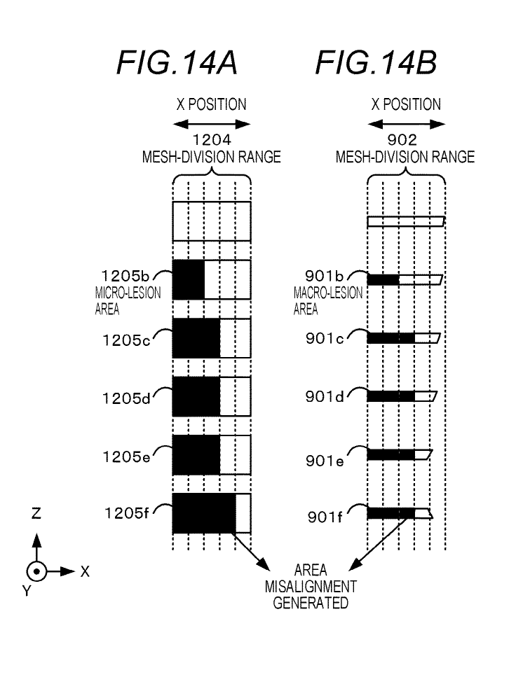

In step S803, the gross image and the slide images are aligned. Details will be described in FIG. 14A to FIG. 16.

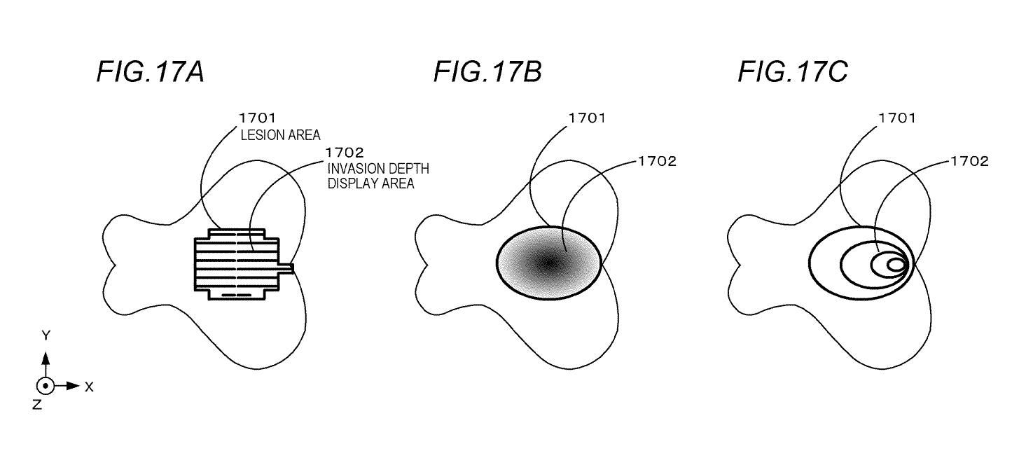

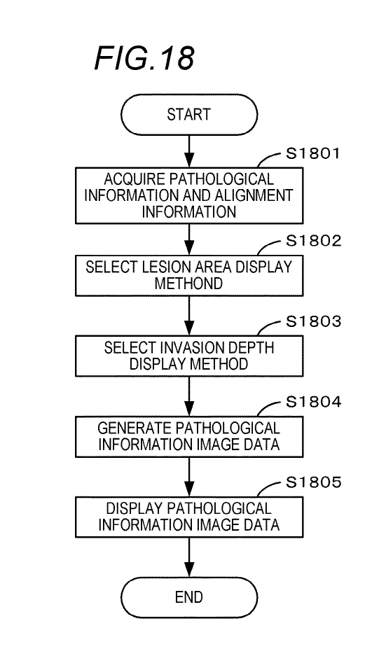

In step S804, the pathological information image data is generated and displayed. Details will be described in FIG. 17A to FIG. 18.

(1) Step S801: Pathological Information Extraction from Gross Image

FIG. 9A to FIG. 9C are schematic diagrams depicting the pathological information extraction from the gross image. FIG. 9A shows a gross image acquired by imaging a gross organ before extirpation (step S203 in FIG. ). The gross image is saved as 2D (two-dimensional) or 3D (three-dimensional) digital data.

FIG. 9B shows a gross extirpation image. This image is generated by adding the extirpation lines to the gross image in FIG. 9A, to indicate the extirpation positions. In step S203 in FIG. 2, the gross organ is extirpated along the extirpation lines indicated in this gross extirpation image. There are two methods to specify extirpation areas: a user specification (manual specification), and a computer specification (automatic specification). In the case of manual specification, the user recognizes the area of the lesion 408 in the gross organ (actual organ) or the gross image, and sets the extirpation areas on the gross image displayed on the monitor screen of the computer using such an operation device as a mouse. In the case of automatic specification, the computer analyzes the gross image, extracts (detects) the area of the lesion 408, and sets the extirpation areas so as to include the extracted (detected) area. If it is difficult to automatically extract the lesion, the user may select the area of the lesion 408 (semi-automatic specification).

FIG. 9C shows gross pathological information. In this example, a range of each extirpation area in the X direction (hereafter called “mesh-division range 902”) is mesh-divided into five cells, and a set of cells that includes the lesion 408 (area filled in black) is called a “macro-lesion area 901”. The gross pathological information is information that includes an area of the lesion 408 extracted from the gross image, the mesh-divided extirpation area, the macro-lesion area 901 and the positional relationship thereof. This information may be saved in any data format only if the positional relationship of mutual areas can be defined. For example, information on the area of the lesion 408 and the macro-lesion area 901 may be saved as mask image data, and the information on the extirpation area may be saved as image coordinates (XY coordinates). The macro-lesion area 901 may be expressed by the number of extirpation areas and the numbers of divided cells, for example.

As shown in FIG. 3, the stomach extirpation patterns have versatility, so if each stomach extirpation pattern is stored as CG (computer graphic) data, the gross pathological information data can be stored as CG data. In this case, the data generated by mapping the area of the lesion 408 extracted from the gross image, the mesh-divided extirpation area, and the macro-lesion area 901 in the CG data are stored as gross pathological information.

FIG. 10A is a flow chart depicting pathological information extraction from the gross image. FIG. 10B is a flow chart depicting the extirpation area specification.

First the flow of the pathological information extraction from the gross image will be described with reference to FIG. 10A.

In step S1001, the gross body image is acquired. In this processing, the computer reads data on the gross image shown in FIG. 9A from a storage device, for example.

In step S1002, the lesion area is extracted. For example, the user observes the gross organ (actual organ) or the gross image, and specifies the area of the lesion 408. Then using such an operation device as a mouse, the user specifies the lesion area for the gross image or the CG of the gross organ displayed on the monitor screen of the computer. As mentioned above, the computer may automatically extract and set the lesion area based on the image analysis. The lesion area extracted in this step is called an “extracted lesion area”.

In step S1003, the extirpation area is specified. There are two methods to specify extirpation areas: a user specification (manual specification), and a computer specification (automatic specification). If the user specifies the extirpation area, the user specifies the extirpation area in the gross image or the CG of the gross organ displayed on the monitor screen of the computer using such an operation device as a mouse. The computer specification (automatic specification) will now be described with reference to FIG. 10B. This step corresponds to FIG. 9B.

In step S1004, the lesion area and the divided cells are corresponded. First the mesh-division range 902 in each extirpation area is divided into 5 cells. Then it is determined whether each divided cell overlaps with the area of the lesion 408, and a divided cell that includes the lesion 408 is regarded as a “lesion area”. For example, the lesion area and the divided cells can be corresponded to each other by attaching a “1” flag to a lesion-area divided cell, and attaching a “0” flag to a non-lesion-area divided cell. The area constituted by a set of divided cells to which the “1” flag set is attached is the above mentioned macro-lesion area 901. By this step, the area of the lesion 408 extracted from the gross image, the mesh-divided extirpation area, the macro-lesion area 901 and the positional relationship thereof are stored as the gross pathological information.

FIG. 10B is an example of the detailed flow of step S1003 in FIG. 10A. A method for specifying the extirpation area by computer (automatic specification) will be described with reference to FIG. 10B.

In step S1005, the extirpation dimension is acquired. The extirpation dimension is determined with regard to the thin sliced sample, that is later mounted on a slide. In the case of FIG. 5B, the extirpation dimension is set to 50 mm. Data on the extirpation dimension, which is set in advance, may be read or the extirpation dimension which the user inputted to the computer by an operation device may be used. The computer may automatically determine an appropriate extirpation dimension based on the dimensions of the gross image or the lesion area and the dimensions of the slide.

In step S1006, the extirpation area, other than the extracted lesion area, extracted in step S1002, is specified. Lesions of a stomach often occur in the lessor curvature, hence in this example, the lesser curvature area is specified as the extirpation area, besides the extracted lesion area. To specify the extirpation area in this step, either the manual specification by the user or the automatic specification by the computer can be used. In the case of the manual specification, a desired area on the gross image can be specified using such an operation device as a mouse, for example. In the case of the automatic specification, an area where a lesion easily occurs (e.g. lesser curvature) can be detected based on the image analysis.

In step S1007, the extirpation area is mapped. The extirpation area is mapped so as to include the target area constituted by the lesion area extracted in step S1002 and the area specified in S1006. The mapping can be implemented using a simple algorithm, such as determining a rectangular area in which a target area is inscribed, and arranging the extirpation area such that this rectangular area is included. The user may adjust the position of the extirpation area after automatic mapping is performed by the computer.

In step S1008, a number is assigned to the extirpation area. A number is assigned to each extirpation area so that the positional relationship between the slides created later and the gross image can be recognized. In this example, one slide is created for each extirpation area, hence numbers in a series are assigned to the 21 extirpation areas respectively (see FIG. 7B).

(2) Step S802: Pathological Information Extraction from Slide Image

FIG. 11A and FIG. 11B show a schematic diagram and a table depicting the pathological information extraction from a slide image.

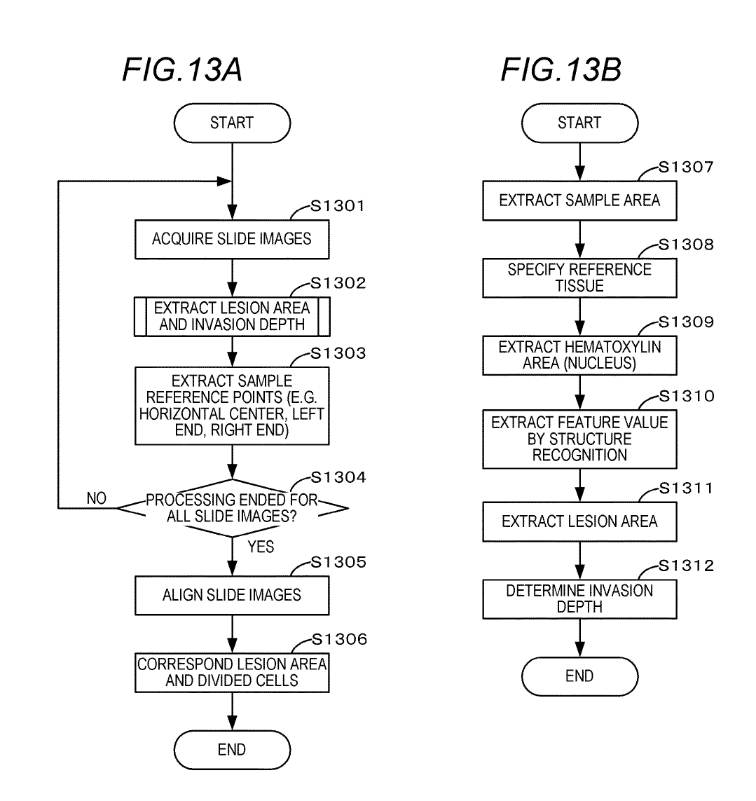

FIG. 11A shows a slide image. A slide image is an image created by imaging a sample on the slide created in step S204 in FIG. 2, which is also called a “sample image”. To capture a slide image, a digital microscope or a digital camera may be used. A thin sliced sample 1102 is mounted on the slide 1101 such that the gastric mucosa side is face up and the gastric serosa side is face down. This corresponds to the Z axis direction in FIG. 7A, where the positive direction in the Z axis is the mucosa side (inner side of the stomach), and the negative direction in the Z axis is the serosa side (outer side of the stomach). For the thin sliced sample 1102, a range of the lesion 1103 is specified in the monitor screen of the computer using such an operation device as a mouse. Here an image of a slide that includes a label is illustrated as the slide image, but only the area excluding the label (area where the thin sliced sample 1102 is mounted) may be generated as the slide image. The lesion 1103 may be extracted by the user (manual extraction) or extracted manually via computer assistance (semi-automatic extraction). The method of extracting the lesion with computer assistance (semi-automatic extraction) will be described with reference to FIG. 13B.

FIG. 11B is a table for explaining the invasion depth criteria. In the pathological diagnosis, the invasion depth of a lesion 1103 in the negative direction of the Z axis is determined. Invasion depth is one index to determine the malignancy of a cancer. The invasion depth (infiltration degree) is determined by the layer of the thin sliced sample 1102 into which the cancer infiltrated, such as the mucosa-fixing layer, the sub-mucosa, the lamina propria, the sub-serosa, and the serosa. The table in FIG. 11B is a table that simplifies the criteria that is widely used to explain the depth (infiltration degree) of a stomach cancer.

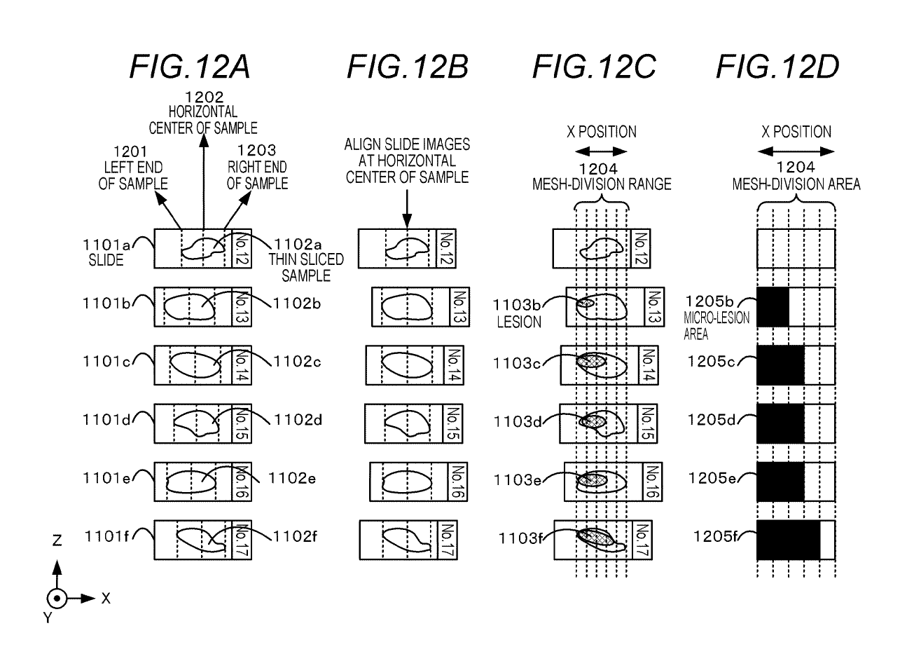

FIG. 12A to FIG. 12D are schematic diagrams depicting the alignment of a plurality of slide images. The plurality of slides are created in step S204 in FIG. 2, but the positions of the thin sliced samples 1102 of the respective slides are not aligned. Further, the length of each thin sliced sample 1102 is not always the same, due to the trimming in the slide creation step or the like. Therefore it is necessary to correct a mismatch of the position and length of each thin sliced sample 1102. In order to visually link the slide pathological information and the gross pathological information, it is preferable that the slide pathological information acquired from each slide is arranged in a three-dimensional space of the gross organ. For this it is necessary to correct the mismatch of the position and length of each thin sliced sample 1102 among the slides.

FIG. 12A is a schematic diagram depicting how the position and the length of each thin sliced sample 1102a to 1102f in X direction are different among the plurality of slides 1101a to 1101f. To clearly show the deviation of the position and length of each thin sliced sample 1102a to 1102f, three dotted lines that indicate the left end of the sample 1201, the horizontal center of the sample 1202, and the right end of the sample 1203 are drawn on each slide 1101a to 1101f. When the slide 1101a and the slide 1101b are compared, it is known that the thin sliced sample 1102a shifted to the right in the X direction, and the sample length is slightly shorter than the thin sliced sample 1102b.

FIG. 12B is a schematic diagram after the slide images are aligned in the X direction at the horizontal center of the sample 1202. The X direction here can be regarded as the lesion spreading direction, and FIG. 12B is regarded as a diagram depicting the alignment of the plurality of slides in the lesion spreading direction.

FIG. 12C is a schematic diagram depicting a mesh-division of the slide images. The positions at both ends of the mesh-division range are determined so as to include the entire range of the thin sliced samples 1102a to 1102f in the X direction. If the slide images in the X direction are aligned at the horizontal center of the samples 1202, the left and right ends of the thin sliced sample of which length in the X direction is the longest, out of all the thin sliced samples 1102a to 1102f, become the respective ends of the mesh-division range. In this example, the mesh-division (1204) that divides the sample into 5 in the X direction was shown, which corresponds to the mesh-division of the extirpation area in FIG. 9C. The shaded ellipse in FIG. 12C indicates the lesions 1103a to 1103f.

FIG. 12D is a schematic diagram depicting the correspondence of the micro-lesion area and the divided cells of the slide images. In this example, the mesh-division range 1204 of each slide image is divided into 5 cells, and the set of cells including the lesion (area filled with black) is regarded as the micro-lesion area. In FIG. 12D, the micro-lesion areas 1205b to 1205f of the slides 1101b to 1101f are filled in black. The slide 1101a does not include the micro-lesion area.

The “position” described in FIG. 12A to FIG. 12D is a position in the XZ coordinates defined in each slide image. Here it is assumed that the rotation of the thin sliced sample 1102, which is generated when the thin sliced sample 1102 is mounted on the slide, is ignored, and the horizontal center and the left and right ends of the sample in the X direction of the XZ coordinates of the slide image are determined.

The slide pathological information in this example is information that includes an area of the lesion 1103, mesh-divided slide image, micro-lesion area 1205, and invasion depth of the thin sliced sample 1102. The area of the lesion 1103 can be expressed in a mask image, for example. The “mesh-divided slide image” refers to an image inside the mesh-division range 1204 shown in FIG. 12C, and is generated by trimming the original slide image. The micro-lesion area 1205 may be indicated by a mask image, or indicated by a number of a divided cell. The invasion depth of the thin sliced sample 1102 is T0 to T3, as shown in FIG. 11B. The slide pathological information is extracted from the plurality of slides respectively. Since the thin sliced sample 1102 is the XY cross-section, if expressed in a simple manner the micro-lesion area corresponds to the X direction information of the slide image, and the invasion depth corresponds to the Z direction information of the slide image (more precisely, invasion depth is determined for the mucosa-fixing layer, sub-mucosa, lamina propria layer, sub-serosa and serosa).

FIG. 13A is a flow chart depicting the pathological information extraction from the slide image. FIG. 13B is a flow chart depicting extraction of a lesion area and invasion depth.

First the flow of pathological information extraction from the slide image will be described with reference to FIG. 13A.

In step S1301, slide images are acquired. This step is, for example, a processing operation where the computer reads data of a plurality of slide images from a storage device shown in FIG. 12A.

In step S1302, a lesion area and an invasion depth are extracted. There are two methods to extract the lesion area and invasion depth: extraction by the user (manual extraction), and extraction with computer assistance (semi-automatic extraction). If the user extracts the lesion 1103 from the slide image, the user specifies the recognized range of the lesion 1103 in the slide image displayed on the monitor screen of the computer using such an operation device as a mouse. The extraction with computer assistance (semi-automatic extraction) will be described with reference to FIG. 13B.

In step S1303, sample reference points are extracted. The sample reference points are: center, left end, right end or the like points of the thin sliced sample 1102 in the X direction. This step corresponds to FIG. 12A.

In step S1304, it is determined whether the processing operations from steps S1301 to S1303 have been executed for all slide images. If the processing operations are completed for all slide images, processing advances to step S1305.

In step S1305, the slide images are aligned. Each slide image is aligned in the X direction using the sample reference points extracted in step S1303. This step corresponds to FIG. 12B.

In step S1306, the lesion area and divided cells are corresponded. First the mesh-division range 1204 in each slide image is divided into 5 cells. Then it is determined whether each divided cell overlaps with the lesion 1103, and a divided cell that includes the lesion 1103 is regarded as a micro-lesion area. For example, the lesion area and the divided cells can be corresponded by attached a “1” flag to a divided cell which is a micro-lesion area, and attaching a “0” flag to a divided cell which is a non-micro-lesion area. By this step, the area of the lesion extracted from the slide images, the mesh-divided slide images, the micro-lesion area 1205 and the invasion depth of the thin sliced samples are stored as the slide pathological information.

FIG. 13B is a flowchart showing an example of the detailed flow of step S1302 in FIG. 13A. The flow of extraction of the lesion area and invasion depth will be described with reference to FIG. 13B.

In step S1307, the sample area is extracted. The area of the thin sliced sample 1102 is extracted from the slide image. The area can be extracted using a simple algorithm, such as binarizing the image after adjusting the histogram.

In step S1308, reference tissues (mucosa-fixing layer, sub-mucosa, lamina propria, sub-serosa and serosa) are specified. To determine the invasion depth according to FIG. 11B, it is necessary to recognize the mucosa-fixing layer, sub-mucosa, lamina propria, sub-serosa and serosa in the thin sliced sample 1102. The user specifies the reference tissues in the slide image data on the monitor screen of the computer using such an operation device as a mouse.

In step S1309, a hematoxylin area (nucleus) is extracted. In biopsy, the thin sliced sample 1102 is stained by hematoxylin-eosin (HE). Hematoxylin is a bluish-purple dye used to stain the nucleus of a cell or the like, and eosin is a pink dye used to stain cytoplasm or the like. In this step, the hematoxylin area (nucleus) that is stained bluish-purple is extracted using the color information of the slide image data.

In step S1310, a feature value is extracted by structure recognition. For the structure recognition, an algorithm that applies graph theory can be used. Based on the information on the nucleus extracted in step S1309, a Voronoi diagram, a Delaunay diagram, a minimum spanning tree or the like are drawn. For example, in the case of the Voronoi diagram, an average, a standard deviation and a minimum-maximum ratio are determined for the area, the perimeter and the length of one side of the polygon (closed area) respectively, and the determined values are regarded as the feature values (9 values). In the case of the Delaunay diagram, an average, a standard deviation and a minimum-maximum ratio are determined for the area and perimeter of the triangle (closed area) respectively, and the determined values are regarded as the feature values (6 values). In the case of the minimum spanning tree, the minimum spanning tree is determined by weighting according to the length of the side, and the average, standard deviation and minimum-maximum ratio of the sides of the minimum spanning tree are determined and regarded as the feature values (3 values).

In step S1311, the lesion area is extracted. The lesion area is extracted based on the plurality of features values extracted in step S1310. A structure of a benign tissue and a structure of a malignant tissue have a difference that can be visually recognized, and whether the tissue is benign or malignant and the degree of malignancy can be determined using a plurality of feature values. In other words, the lesion area can be extracted using a plurality of feature values acquired from the slide images. If in step S1310 the feature values are acquired not only from a Voronoi diagram but also from a Delaunay diagram or a minimum spanning tree, or from slide images filtered by a Gabor filter or the like, comprehensive criteria of the lesion area can be created by combining these feature values. The criteria of the feature values that reflect the characteristics of the tissue may be created for each reference tissue (mucosa-fixing layer, sub-mucosa, lamina propria, sub-serosa and serosa).

In step S1312, the invasion depth is determined. The invasion depth (infiltration degree) is determined by the layer of the reference tissue (mucosa-fixing layer, sub-mucosa, lamina propria, sub-serosa and serosa) specified in step S1308, into which the lesion area, determined in step S1311, infiltrated.

(3) Step S803: Alignment of Gross Image and Slide Images

The macro-lesion area and the micro-lesion area will be described with reference to FIG. 14A and FIG. 14B.

FIG. 14A is a schematic diagram depicting the correspondence of the micro-lesion areas of the slide images and divided cells, which is the same as FIG. 12D. FIG. 14B is a schematic diagram depicting the correspondence of the macro-lesion areas of the gross image and divided cells, and is the same as the macro-lesion area 901 and mesh-division range 902 shown in FIG. 9C. Here it is assumed that the mesh-division range 1204 and the mesh-division range 902 are the same range. In the slide 1101a to the slide 1101e, the micro-lesion area 1205 (b to e) and the macro-lesion area 901 (b to e) match. In the slide 1101f however, the micro-lesion area 1205f and the macro-lesion area 901f do not match. This means that the lesion range extracted from the gross organ or the gross image and the lesion range extracted from the slide image are different. This difference of the areas cannot be recognized in the gross organ or the gross image, but is a lesion range that is newly recognized in the pathological diagnosis using the slide image.

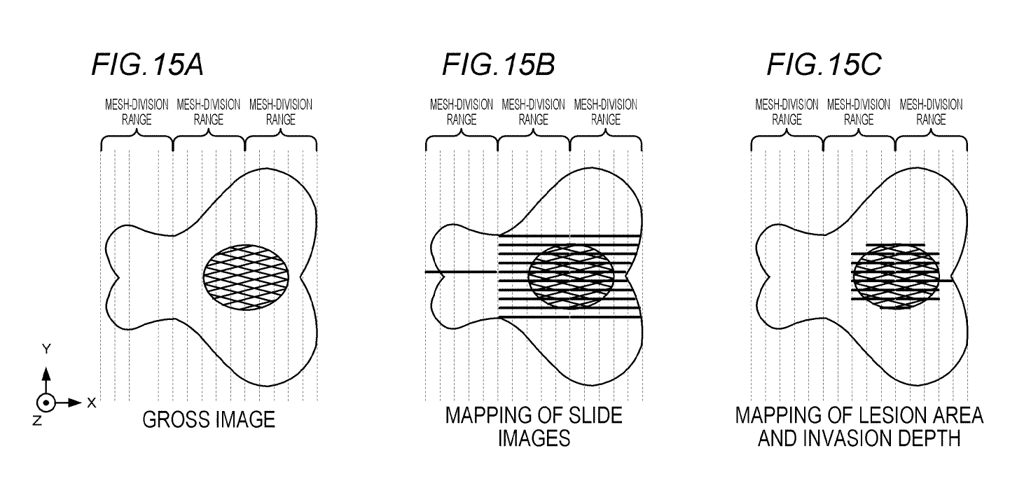

FIG. 15A to FIG. 15C are schematic diagrams depicting alignment of a gross image and slide images.

FIG. 15A shows a gross image which is the same as FIG. 9A. To simplify description on alignment of the gross image and the slide images, the mesh-division range is also indicated.

FIG. 15B is a schematic diagram mapping the slide images in the gross image. After executing the alignment of the plurality of slide images described in FIG. 12A to FIG. 12C, the slide images are mapped in the gross image. Note that here the X direction of the slide images is limited to the mesh-division range 1204. The mapping positions of the slide images in the X direction are set to the mesh-division range (902, 1204). The mapping positions of the slide images in the Y direction are aligned to the thin sliced surface 601 of the extirpation area 501 (see FIG. 5 and FIG. 6). In FIG. 15B, the positions of the gross image and the slide images (not only the XY positions but the XYZ positions that include the Z positions) clearly correspond to each other.

FIG. 15C is a schematic diagram mapping the lesion area and the invasion depth on the gross image. The lesion area includes a macro-lesion area 901 included in the gross pathological information and a micro-lesion area 1205 included in the slide pathological information, and each information is independently mapped as a lesion area (link of position data).

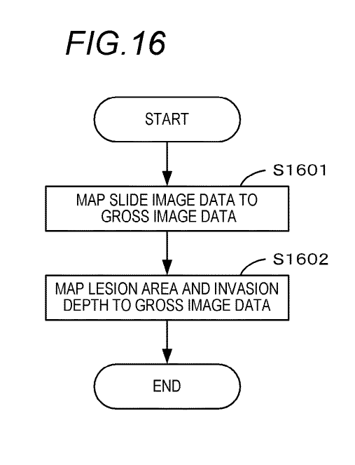

FIG. 16 is a flow chart depicting alignment of the gross image and the slide images.

In step S1601, the slide image data is mapped on the gross image data. Information required for correspondence and alignment between the gross image and the slide images is acquired from the gross pathological information and the slide pathological information. This step corresponds to FIG. 15B.

In step S1602, the lesion area and invasion depth are mapped on the gross image data. Information on the lesion area in the gross image and information on the lesion area and invasion depth of the slide images are acquired from the gross pathological information and the slide pathological information respectively. The lesion area includes the macro-lesion area 901 and the micro-lesion area 1205, and the respective lesion areas may not match in some cases, as shown in FIG. 14A and FIG. 14B. Therefore the information on the macro-lesion area 901 and the information on the micro-lesion area 1205 are mapped as the lesion area (link of position data). This step corresponds to FIG. 15C.

(4) Step S804: Generation and Display of Pathological Information Image Data

FIG. 17A to FIG. 17C are schematic diagrams depicting the generation and display of pathological information image data. In FIG. 15A to FIG. 15C and FIG. 16, mapping of the lesion area and invasion depth on the gross image (link of position data) was described. Here a method of generating and displaying image data to visually and intuitively recognize the lesion area and invasion depth will be described.

FIG. 17A is a display method where the lesion area 1701 is encircled by a polygon, and the invasion depth is color-coded in the invasion depth display area 1702. The lesion area includes the macro-lesion area 901 and the micro-lesion area 1205, and the logical sum thereof is encircled by the polygon and displayed. For the inversion depth, T0 to T3 are color-coded red, yellow, green, blue or the like, for example.

FIG. 17B is a display method where the lesion area 1701 is encircled by an ellipse, and the invasion depth is interpolated and expressed. The information on the invasion depth acquired as the slide pathological information is discrete information on the XY cross-section (see FIG. 15C). This discrete invasion depth information is converted into continuous information using such interpolation processing operations as nearest neighbor interpolation, bilinear interpolation and cubic interpolation, so that the invasion depth is expressed by continuously changing pseudo-colors (e.g. red to blue). By an interpolated display like this, where the invasion depth continuously changes in the pathological information image, the distribution of the lesion in the depth direction can be more easily recognized.

FIG. 17C is a display method where the lesion area 1701 is encircled by an ellipse, and the invasion depth is interpolated and displayed as contour lines. The interpolation of the invasion depth is the same as the processing in FIG. 17B, and an area having a same invasion depth is expressed as a contour line. The invasion depth may be expressed by a combination of continuous pseudo-colors and contour lines.

Besides the display methods described here, the micro-lesion area 901 and the micro-lesion area 1205 may be switchable in the display of the lesion area, or the micro-lesion area 1205 may be displayed with priority. To express the invasion depth, gradation may be used in addition to using pseudo-colors and contour lines.

The possible data display formats are, for example: 2D digital data, 3D digital data and CG data. The 2D digital data is a display format where the lesion area 1701 and the invasion depth display area 1702 are combined with two-dimensional gross image data. The 3D digital data is a display format where the lesion area 1701 and the invasion depth display area 1702 are combined with three-dimensional gross image data. The CG data is a display format where the gross image is created by CG, and the lesion area 1701 and the invasion depth display area 1702 are combined with CG data. Either two-dimensional gross CG or three-dimensional gross CG may be used.

FIG. 18 is a flow chart depicting the generation and display of pathological information image data.

In step S1801, the pathological information and the alignment information are acquired. The pathological information refers to the gross pathological information and the slide pathological information. The gross pathological information includes information on the area of the lesion 408 extracted from the gross image, mesh-divided extirpation area, macro-lesion area 901 and positional relationships thereof. The slide pathological information includes information on the area of the lesion 1103, mesh-divided slide images, micro-lesion area 1205, and invasion depth of the thin sliced samples 1102. The alignment information is information to correspond the positional relationships of the macro-lesion areas and the micro-lesion areas.

In step S1802, a lesion area display method is selected. The lesion area display method is, for example, displaying the edge as a rectangle or an ellipse. In step S1803, an invasion depth display method is selected. The invasion depth display method is, for example, a continuous display or a discrete display, a color display or a contour line display. For example, a display method setting GUI is displayed on the monitor screen, and the user selects a desired display method using such an operation device as a mouse.

In step S1804, the pathological information image data is generated. The pathological information image data that is displayed is generated using the gross pathological information, slide pathological information, alignment information, pathological area display method and invasion depth display method.

In step S1805, the pathological information image data generated in S1804 is displayed.

### Advantage of Image Processing Method of This Example

According to the image processing method of this example, an image processing method that allows intuitively recognizing the correspondence of the pathological information and the clinical information can be provided. In the pathological diagnosis, the lesion area and invasion depth in the gross organ in its entirety are recognized by integrating the micro-pathological information extracted from the discretely sampled slides and the macro-pathological information extracted from the gross organ. The lesion area and invasion depth thereof are important information not only for the pathologist and the clinician, but also for the patient, in order to judge the stage of the illness and determine the treatment plan. By visualizing the correspondence between the micro-pathological information and the macro-pathological information in such a way that intuitive recognition is possible, the user (pathologist) can more accurately and quickly transfer the pathological information, including the lesion area and invasion depth, to the clinician and the patient. Thereby inconsistency in the information transfer can be decreased, and information can be transferred more efficiently.

### Configuration Example of Image Processing System

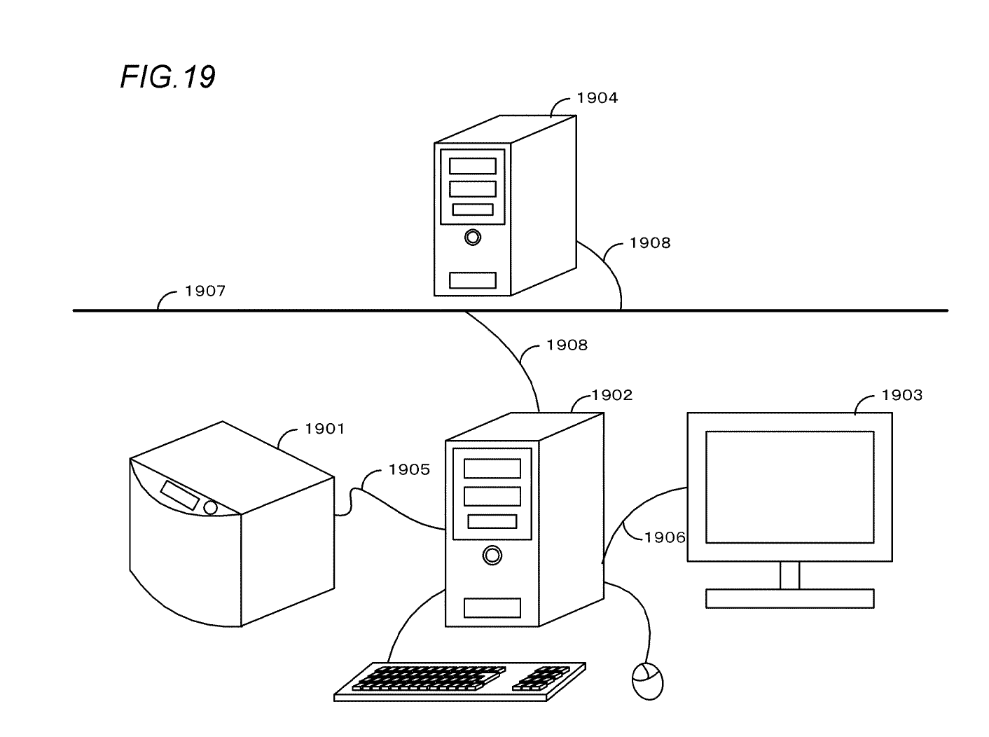

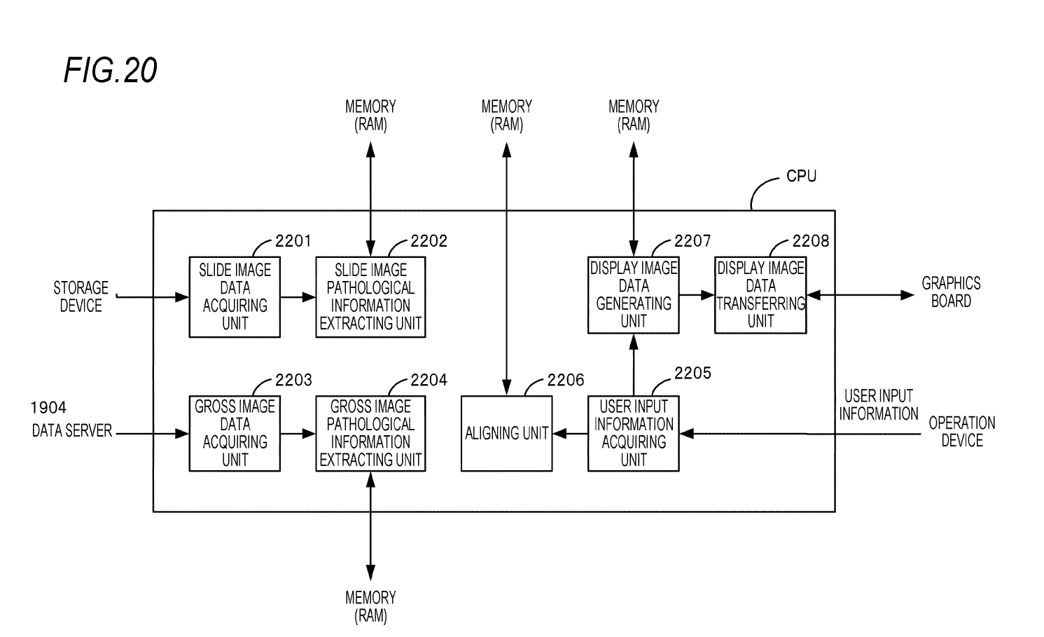

An example of an image processing system to execute the above mentioned image processing method will be described with reference to FIG. 19 and FIG. 20.

FIG. 19 is a general view of a device configuration of the image processing system. The image processing system is constituted by an imaging apparatus (digital microscopic apparatus, or virtual slide scanner) 1901, an image processor 1902, a display device (monitor) 1903, and a data server 1904. The image processing system has a function to acquire and display two-dimensional images of a gross organ (object) and slides. The imaging apparatus 1901 and the image processor 1902 are connected by a dedicated or a general purpose I/F cable 1905, and the image processor 1902 and the display device 1903 are connected by a general purpose I/F cable 1906. The data server 1904 and the image processor 1902 are connected by a LAN cable 1908 of a general purpose I/F via a network 1907.

The imaging apparatus 1901 is a virtual slide scanner which has a function to image an object at high magnification, and output a high resolution digital image. To acquire the two-dimensional image, a solid state image sensing device, such as a charge coupled device (CCD) or a complementary metal oxide semiconductor (CMOS), is used. The imaging apparatus 1901 may be constituted by a digital microscopic apparatus which has a digital camera housed in the eye piece of a standard optical microscope, instead of the virtual slide scanner.

The image processor 1902 has a function to generate data to-be-displayed on the display device 1903 from a plurality of original image data acquired from the imaging apparatus 1901 according to the request from the user. The image processor 1902 is constituted by a general purpose computer or a workstation which includes such hardware resources as a central processing unit (CPU), memory (RAM), storage device and operation device. The storage device is a large capacity information storage device, such as a hard disk drive, which stores programs, data, the operating system (OS) or the like, to implement the above mentioned image processing method. These functions are implemented by the CPU that loads from the storage device the programs and data required for a memory, and executes the programs. The operation device is constituted by a keyboard, mouse or the like, and is used for the user to input various instructions.

The display device 1903 is a monitor to display the gross image, slide images and gross pathological information, slide pathological information and pathological information images (FIG. 17A to FIG. 17C) computed by the image processor 1902. The display device 1903 is constituted by a liquid crystal display or the like.

The data server 1904 is a mass storage device storing such data as gross images, slide images, gross pathological information, slide pathological information and pathological information images.

In the case of FIG. 19, the image processing system is constituted by four apparatuses: the imaging apparatus 1901, the image processor 1902, the display device 1903 and the data server 1904, but the present invention is not limited to this configuration. For example, an image processor integrated with a display device may be used, or the functions of the image processor may be incorporated into the imaging apparatus. The functions of the imaging apparatus, the image processor, the display device and the data server may be implemented by one apparatus. Conversely, the functions of, for example, the image processor may be implemented by a plurality of apparatuses respectively.

FIG. 20 is a block diagram depicting a functional configuration of the image processor 1902.

In FIG. 20, the functions indicated by the reference numbers 2201 to 2208 are implemented by the CPU of the image processor 1902, which loads the programs and required data from the storage device to memory, and executes the programs. However a part or all of the functions may be implemented by a dedicated processing unit, such as a CPU, or by such a dedicated circuit as an ASIC. Each function 2201 to 2208 will now be described.

The slide image data acquiring unit 2201 acquires slide image data from the storage device. If the slide image data is stored in the data server 1904, the slide image data is acquired from the data server 1904.

The slide image pathological information extracting unit 2202 extracts the slide pathological information from the slide image data, and stores the slide image data and the slide pathological information in the memory (see description on FIG. 11, FIG. 12 and FIG. 13).

The gross image data acquiring unit 2203 acquires the gross image data from the data server 1904.

The gross image pathological information extracting unit 2204 extracts the gross pathological information from the gross image data, and stores the gross image data and the gross pathological information in the memory (see the description on FIG. 9 and FIG. 10).

The user input information acquiring unit 2205 acquires various instruction content inputted by the user using such an operation device as a mouse. For example, lesion area extraction in the gross image (S1002), extirpation area specification (S1003, S1006), extirpation dimension specification (S1005), lesion specification in the slide image (S1302), reference tissue specification in the slide image (S1308) or the like are inputted.

The alignment unit 2206 reads the gross image data and the slide image data from the memory, and aligns the gross image and the slide image (see the description on FIG. 14, FIG. 15 and FIG. 16).

The display image data generating unit 2207 generates the pathological information image data according to the lesion area display method (S1802) or the invasion depth display method (S1803), which were inputted to the user input information acquiring unit 2205 (see the description on FIG. 17 and FIG. 18).

The display image data transfer unit 2208 transfers the image data generated by the display image data generating unit 2207 to the graphics board. High-speed image data transfer between the memory and the graphics board is executed by the DMA function. The image data transferred to the graphics board is displayed on the display device 1903.

According to the image processing system of this example, an image processing method that allows intuitively recognizing the correspondence of the pathological information and the clinical information can be provided. In the pathological diagnosis, the lesion area and invasion depth in the gross organ in its entirety are recognized by integrating the micro-pathological information extracted from the discretely sampled slides, and the macro-pathological information extracted from the gross organ. The lesion area and invasion depth thereof are important information not only for the pathologist and the clinician, but also for the patient, in order to judge the stage of the illness and determine the treatment plan. By visualizing the correspondence between the micro-pathological information and the macro-pathological information in such a way that intuitive recognition is possible, the user (pathologist) can more accurately and quickly transfer the pathological information, including the lesion area and invasion depth, to the clinician and the patient. Thereby inconsistency in the information transfer can be decreased, and information can be transferred more efficiently.

This example is one preferred embodiment of the present invention, and is not intended to limit the scope of the invention. The present invention can be subject to various configurations within the scope of the technical spirit disclosed in the description and Claims. For example, in this example, the lesion area (spread of the lesion in the plane direction (XY direction)) and the invasion depth (infiltration of lesion in the depth direction (Z direction)) were presented as the pathological information, but any information may be presented as the pathological information if the information is on the lesion extracted from the slides and the gross organ. Only the lesion area or only the invasion depth may be presented as the pathological information. In this example, the pathological diagnosis of a stomach cancer was used as an example, but pathological information can be acquired and pathological information image data can be generated by the same processing even if the organ is other than the stomach, or even if the disease is other than a cancer.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-224366, filed on Oct. 29, 2013, which is hereby incorporated by reference herein in its entirety.

What is claimed is:

1. An image processing method, comprising:
acquiring data on a plurality of sample images, acquired by imaging a plurality of samples collected from different positions of a gross organ that includes a lesion, by a computer;
extracting information on the lesion from each of the plurality of sample images; and
generating data on a pathological information image by combining information on the lesion extracted from each of the plurality of sample images, on an image expressing the gross organ, by the computer.

2. The image processing method according to claim 1, wherein
the pathological information image is an image generated by combining information on the lesion extracted from each of the plurality of sample images on corresponding positions on the image expressing the gross organ, so that correspondence between the gross organ and the position where each sample was collected can be recognized.

3. The image processing method according to claim 1, wherein
the information on the lesion includes invasion depth, which is information on the lesion in a depth direction.

4. The image processing method according to claim 3, wherein
in the pathological information image, the invasion depth of each sample image is expressed by pseudo-colors, gradation or contour lines.

5. The image processing method according to claim 4, wherein
an invasion depth between each sample image is interpolated so that the invasion depth continuously changes in the pathological information image.

6. The image processing method according to claim 3, wherein
in the extracting of the information on the lesion, the invasion depth is extracted based on a reference tissue.

7. The image processing method according to claim 1, wherein
the information on the lesion includes a lesion area which is information on the spread of the lesion.

8. The image processing method according to claim 1, further comprising extracting information on the lesion from a gross image acquired by imaging the gross organ, wherein
the information on the lesion extracted from the gross image is also combined on the pathological information image.

9. The image processing method according to claim 1, wherein
the image expressing the gross organ is a gross image acquired by imaging the gross organ, or a computer graphic of the gross organ.

10. The image processing method according to claim 1, wherein
the image expressing the gross organ is a two-dimensional image or a three-dimensional image.

11. The image processing method according to claim 1, further comprising displaying the pathological information image on a display device.

12. The image processing method according to claim 1, wherein
in the extracting of the information on the lesion, the plurality of sample images are aligned based on sample reference points of the plurality of samples, and information on the lesion is extracted from the plurality of aligned sample images.

13. An image processing system, comprising:
an acquiring unit configured to acquire data on a plurality of sample images, acquired by imaging a plurality of samples collected from different positions of a gross organ that includes a lesion;
an information extracting unit configured to extract information on a lesion from each of the plurality of sample images; and
a data generating unit configured to generate data on a pathological information image by combining information on the lesion extracted from each of the plurality of sample images, on an image expressing the gross organ.

14. A non-transitory computer-readable storage medium that records a program for a computer to execute each step of the image processing method according to claim 1.
